(19) United States
(12) Patent Application Publication
(10) Pub. No.: US 2023/0103628 A1
(43) Pub. Date: Apr. 6, 2023

(54) WEBBING WINDING DEVICE

(71) Applicant: KABUSHIKI KAISHA TOKAI-RIKA-DENKI-SEISAKUSHO, Aichi (JP)

(72) Inventors: Chihiro SANO, Aichi (JP); Kazuhiro YAMADA, Aichi (JP)

(21) Appl. No.: 17/909,955

(22) PCT Filed: Jan. 12, 2021
(86) PCT No.: PCT/JP2021/000717

§ 371 Date: Sep. 7, 2022

(30) Foreign Application Priority Data
Mar. 26, 2020 (JP) 2020-056845

(51) Int. Cl. B60R 22/36; B60R 22/46

(52) U.S. Cl. CPC B60R 22/36; B60R 22/46

(57) ABSTRACT

A webbing winding device includes a spool, a sensor lever, and a solenoid. In a state where the sensor lever is disposed at the first position, the rotation in the drawing-out direction of the spool is enabled, and in a state where the sensor lever is disposed at the second position, the rotation in the drawing-out direction of the spool is locked. When the solenoid is actuated, the sensor lever is displaced from the first position to the second position. The sensor lever is provided with a thinned groove being deformed when a part of the sensor lever disposed at the second position is pressed toward the first position, the thinned groove allowing displacement toward the first position of the part of the sensor lever.

### TECHNICAL FIELD

The present invention relates to a webbing winding device.

### BACKGROUND ART

Japanese Patent Application Laid-Open (JP-A) No. 2002-2447 discloses a webbing winding device including a lock mechanism that restricts drawing-out from a spool of a webbing (belt) in emergency of a vehicle, such as at the time of rapid deceleration of a vehicle. In the lock mechanism of the webbing winding device described in this document, a locking pawl is engaged with a gear member provided integrally rotatably with the spool. Accordingly, rotation of the gear member is locked and drawing-out from the spool of the webbing is restricted. In the lock mechanism of the webbing winding device described in this document, the locking pawl is displaced toward the gear member by the solenoid being actuated.

### SUMMARY OF INVENTION

### Technical Problem

Incidentally, in the configuration in which the displacement member such as the locking pawl is displaced by the actuation of the actuation portion such as the solenoid, it is desirable to be able to prevent the displacement member from being difficult to displace toward the original position after the actuation of the actuation portion, for example.

In consideration of the above fact, an object of the present invention is to obtain a webbing winding device capable of preventing it from being difficult to displace the displacement member toward the original position.

### Solution to Problem

A webbing winding device according to a first aspect includes: a spool, a webbing to be attached to an occupant being wound around the spool, the spool being rotated in a drawing-out direction by the webbing being drawn out: a displacement member configured to be displaced between a first position and a second position, rotation in the drawing-out direction of the spool being enabled in a state in which the displacement member is disposed at the first position, and rotation in the drawing-out direction of the spool being locked in a state in which the displacement member is disposed at the second position; and an actuation portion, actuation of the actuation portion causing the displacement member to be displaced from the first position to the second position, wherein the displacement member is provided with a deformation allowing portion that is deformed in a case in which a part of the displacement member disposed at the second position is pressed toward the first position, and the deformation allowing portion is allowed to be displaced toward the first position of the part of the displacement member.

In the webbing winding device according to the first aspect, in a webbing winding device according to a second aspect, the displacement member includes an attracting portion that is attracted to the actuated actuation portion. By the deformation allowing portion being deformed in a state in which the attracting portion is attracted to the actuation portion, displacement toward the first position of the part of the displacement member is allowed.

### Advantageous Effects of Invention

In the webbing winding device according to the first aspect, when the actuation portion is actuated in an emergency of the vehicle, the displacement member is displaced from the first position to the second position, and the rotation in the drawing-out direction of the spool is locked. As a result, drawing-out from the spool of the webbing is restricted.

Here, in the webbing winding device according to the first aspect, when a part of the displacement member disposed at the second position is pressed toward the first position, the deformation allowing portion is deformed, and the displacement toward the first position of the part of the displacement member is allowed. As described above, in the webbing winding device according to the first aspect, it is possible to prevent the displacement member from being difficult to displace toward the original position.

In the webbing winding device according to the second aspect, when the actuation portion is actuated in an emergency of the vehicle, the attracting portion of the displacement member is attracted to the actuation portion, and the displacement member is displaced from the first position to the second position. Accordingly, rotation in the drawing-out direction of the spool is locked and drawing-out from the spool of the webbing is restricted.

Here, in the webbing winding device according to the second aspect, when a part of the displacement member is pressed toward the first position in a state where the attracting portion is attracted to the actuation portion, the deformation allowing portion is deformed, and the displacement toward the first position of the part of the displacement member is allowed. As described above, in the webbing winding device according to the second aspect, it is possible to prevent the displacement member from being difficult to displace toward the original position.

### BRIEF DESCRIPTION OF DRAWINGS

FIG. 1 is an exploded perspective view showing a spool, a main lock, and the like constituting a part of a webbing winding device.

FIG. 2 is an exploded perspective view showing a solenoid, a sensor lever, a pawl, and the like constituting a part of a lock mechanism.

FIG. 3 is a side view showing a solenoid, a sensor lever, a pawl, and the like constituting a part of the lock mechanism, and shows a state in which the solenoid is stopped.

FIG. 4 is a side view showing a solenoid, a sensor lever, a pawl, and the like constituting a part of the lock mechanism, and shows a state in which the solenoid is actuated.

FIG. 5 is a side view showing a sensor lever and the like to which a configuration for preventing or suppressing a problem is applied.

FIG. 6 is a side view corresponding to FIG. 5 showing the sensor lever and the like to which the configuration for preventing or suppressing the problem is applied, and shows a state where the sensor lever disposed at the second position is pressed by the pawl.

FIG. 7 is a side view showing the sensor lever and the like to which the configuration for preventing or suppressing the problem is applied, and shows a state where the sensor lever disposed at the second position is pressed by the pawl.

### DESCRIPTION OF EMBODIMENTS

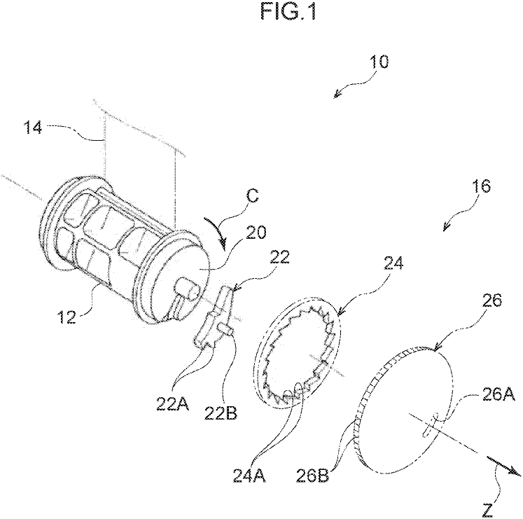

A webbing winding device according to an embodiment of the present invention will be described with reference to FIGS. 1 to 4.

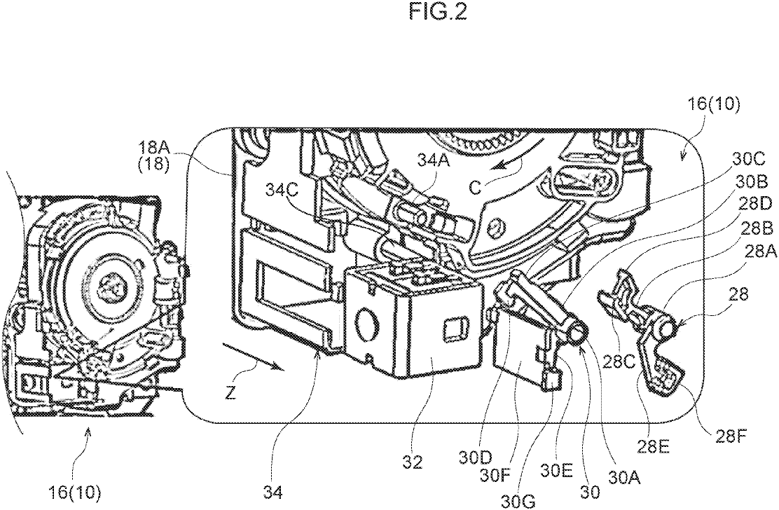

As shown in FIGS. 1 and 2, the webbing winding device 10 of the present embodiment includes a spool 12, a webbing 14. and a lock mechanism 16. Hereinafter, unless otherwise noted, when the axial direction, the radial direction, and the circumferential direction are simply indicated, the rotational axial direction, the rotational radial direction, and the rotational circumferential direction of the spool 12 are indicated.

As shown in FIG. 1, the spool 12 is formed in a substantially cylindrical shape. Between a pair of leg pieces 18A of a frame 18 (see FIG. 2), the spool 12 is rotatably supported by the frame 18. A known torsion shaft (not shown) constituting a force limiter mechanism is disposed inside the spool 12. A lock base 20 is provided on one side in the axial direction (arrow Z direction side) of the spool 12. The lock base 20 is coupled to the spool 12 through the torsion shaft. The spool 12 is rotationally urged in the winding direction by a winding urging mechanism (not shown).

The webbing 14 is attached to the body of an occupant seated on a vehicle seat, and has a base end portion, which is one end portion in the longitudinal direction, locked to the spool 12. The spool 12 is rotationally urged in a winding direction (direction of an arrow C in FIG. 1 and the like) being one rotation direction by an urging force of a spiral spring constituting a part of a winding urging mechanism. Then, the spool 12 is rotated in the winding direction, whereby the webbing 14 is wound around the spool 12 from the base end side. The webbing 14 is drawn out from the spool 12, whereby the spool 12 is rotated in a drawing-out direction (direction opposite to the arrow C in FIG. 1 and the like) being the other rotation direction. A winding mechanism such as a pretensioner mechanism that rotates the spool 12 in the winding direction in an emergency or the like of the vehicle described below may be provided.

Next, the lock mechanism 16 of the main part of the present embodiment will be described.

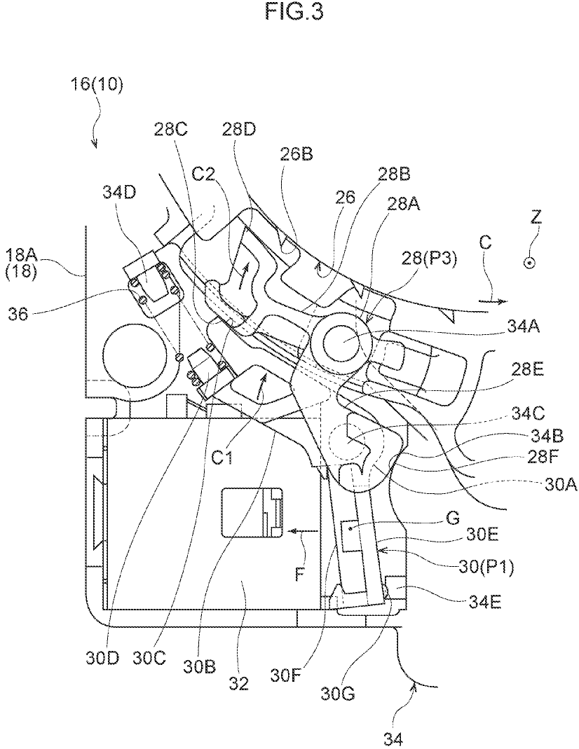

As shown in FIG. 1, the lock mechanism 16 includes a main lock 22 supported by the lock base 20 and a main lock engagement portion 24 with which the main lock 22 is engaged. The lock mechanism 16 includes a pawl engagement member 26 as an engagement member provided to be integrally rotatable with the spool 12. As shown in FIGS. 2 and 3, the lock mechanism 16 includes a pawl 28 and a sensor lever 30 disposed radially outside the pawl engagement member 26, and a solenoid 32 disposed to face the sensor lever 30.

As shown in FIG. 1, the main lock 22 is formed in a substantially rectangular block shape. The base end side of the main lock 22 is supported in a tiltable manner by a main lock support portion provided on the lock base 20. On the radially outer side on the tip side of the main lock 22, a main lock engaging tooth 22A to be engaged with a main lock tooth to be engaged 24A of the main lock engagement portion 24 described below is formed. Then, the main lock 22 is tilted (displaced) radially outward with the main lock support portion as a supporting shaft portion, whereby the main lock engaging tooth 22A is engaged with the main lock tooth to be engaged 24A of the main lock engagement portion 24. The main lock 22 is provided with a cylindrical protrusion 22B protruding toward one side in the axial direction.

The main lock engagement portion 24 is formed in an annular shape as an example, and a plurality of main lock tooth to be engaged 24A (ratchet teeth) are formed along the circumferential direction in the inner circumferential portion of the main lock engagement portion 24. The main lock engagement portion 24 may be formed integrally with the frame 18 (see FIG. 2) that supports the spool 12, or may be provided separately from the frame 18.

The pawl engagement member 26 is formed in a disc shape. A radially central portion of the pawl engagement member 26 is rotatably supported by a torsion shaft (not shown) or a lock base 20. On the radially outer side of the portion supported by the torsion shaft (not shown) or the lock base 20 in the pawl engagement member 26, a long hole-shaped actuation groove 26A in which the protrusion 22B of the main lock 22 is disposed inside is formed. A plurality of pawl tooth to be engaged 26B (ratchet teeth) with which a pawl engaging tooth 28D of the pawl 28 described below is engaged are formed along the circumferential direction in the outer circumferential portion of the pawl engagement member 26. The above-described pawl engagement member 26 is rotationally urged in the drawing-out direction with respect to the lock base 20 by a coil spring (not shown) provided between the pawl engagement member 26 and the lock base 20, and has the rotation by the coil spring in the drawing-out direction with respect to the lock base 20 locked.

As shown in FIG. 2, the pawl 28 is supported in a tiltable (rotationally displaceable) manner by the housing 34. The housing 34 is attached to the frame 18. A main lock engagement portion 24, a main lock 22, and the like (see FIG. 1) are disposed inside the housing 34.

The pawl 28 includes a tubular portion 28A that is rotatable around a cylindrical first supporting shaft portion 34A that is provided in the housing 34. by inserting the first supporting shaft portion 34A. The pawl 28 includes a first arm portion 28B that protrudes from the other side in the axial direction (side opposite to the direction of arrow Z) of the tubular portion 28A toward the outer side in the radial direction of the tubular portion 28A. A pawl first abutting portion 28C on which a part of the first arm portion 30B abuts is formed on the first arm portion 30B side of the sensor lever 30 described below in the tip portion of the first arm portion 28B. On the side opposite to the pawl first abutting portion 28C in the tip portion of the first arm portion 28B, a pawl engaging tooth 28D to be engaged with a pawl tooth to be engaged 26B (see FIG. 3) of the pawl engagement member 26 is formed. The pawl 28 further includes a second arm portion 28E that protrudes from one axial side (arrow Z direction side) of the tubular portion 28A toward the radially outer side of the tubular portion 28A and the side opposite to the direction in which the first arm portion 28B protrudes. A pawl second abutting portion 28F which abuts on the housing first abutting portion 34B (see FIG. 3) of the housing 34 is formed in a tip portion of the second arm portion 28E.

The sensor lever 30, as a displacement member, includes a tubular portion 30A that is rotatable around a cylindrical second support shaft portion 34C that is provided in the housing 34, by inserting the second support shaft portion 34C. The sensor lever 30 includes a first arm portion 30B that protrudes from one side in the axial direction (arrow Z direction side) of the tubular portion 30A toward the outer side in the radial direction of the tubular portion 30A. On the pawl first abutting portion 28C side of the first arm portion 28B of the pawl 28 in the tip portion of the first arm portion 30B. a sensor lever first abutting portion 30C as an engagement portion abutting on the pawl first abutting portion 28C is formed. As shown in FIG. 3, a sensor lever-side spring locking portion 30D to which an end portion on one side of the return spring 36 is locked is formed on the side opposite to the sensor lever first abutting portion 30C in the tip portion of the first arm portion 30B. An end portion on the other side of the return spring 36 is locked to a housing-side spring locking portion 34D provided in the housing 34. Then, the return spring 36 is deformed along with the tilt of the sensor lever 30 (tilt toward a second position P2 described below), whereby the sensor lever 30 is urged toward a first position P1 described below.

As shown in FIG. 2, the sensor lever 30 includes a second arm portion 30E as an attracting portion that protrudes from the tubular portion 30A toward the radially outer side of the tubular portion 30A and the side opposite to the direction in which the first arm portion 30B protrudes. A plate 30F as an attracting portion is fixed to the solenoid 32 side described below in the second arm portion 30E. The plate 30F is formed in a rectangular plate shape using iron or steel metal as an example, and constitutes a part of the sensor lever 30 The plate 30F may be embedded inside the second arm portion 30E. As shown in FIG. 3, a sensor lever second abutting portion 30G abutting on the housing second abutting portion 34E of the housing 34 is formed in the tip portion of the second arm portion 30E and on one side in the axial direction (arrow Z direction side).

The solenoid 32 as an actuation portion generates a magnetic field when applied with a predetermined voltage and energized (actuated). As an example, the solenoid 32 is configured by winding a conducting wire around an iron core (a coil is formed around the iron core).

Then, as shown in FIG. 3, in a state where the solenoid 32 is not energized (the solenoid 32 is not actuated), the sensor lever 30 takes a predetermined attitude with respect to the housing 34. The position of the sensor lever 30 in this state is referred to as a first position P1. In a state where the sensor lever 30 is disposed at the first position P1, a state where the sensor lever first abutting portion 30C of the sensor lever 30 abuts on the pawl first abutting portion 28C of the pawl 28, and a state where the pawl second abutting portion 28F of the pawl 28 abuts on the housing first abutting portion 34B of the housing 34 are brought about, so that the pawl 28 takes a predetermined attitude with respect to the housing 34. The position of the pawl 28 in this state is referred to as an engagement-release position P3. In the state where the pawl 28 is positioned at the engagement-release position P3, the pawl engaging tooth 28D of the pawl 28 cannot engage with the pawl tooth to be engaged 26B of the pawl engagement member 26 (is separated from each other).

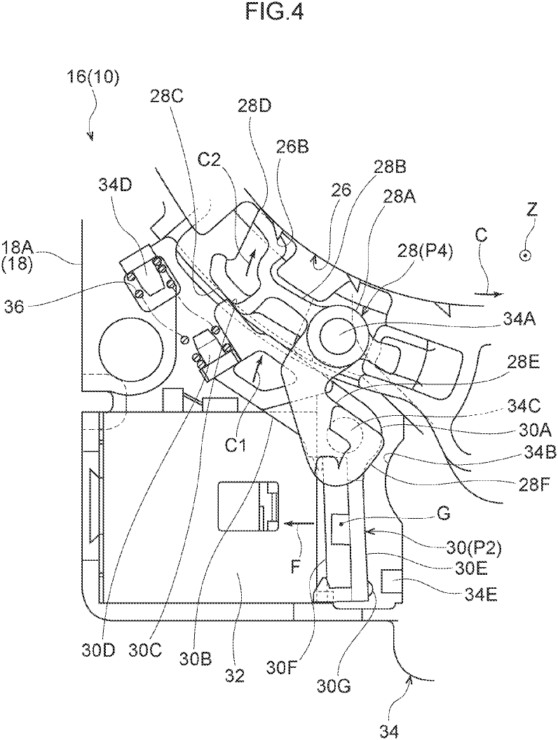

On the other hand, as shown in FIG. 4, when the solenoid 32 is actuated, the second arm portion 30E (plate 30F) of the sensor lever 30 is attracted to the solenoid 32, and the sensor lever 30 is tilted from the first position P1 to one side (arrow C1 direction side) around the second supporting shaft portion 34C. When the sensor lever 30 is tilted from the first position P1 to one side (arrow C1 direction side) around the second supporting shaft portion 34C, the sensor lever first abutting portion 30C of the first arm portion 30B of the sensor lever 30 presses the pawl first abutting portion 28C of the pawl 28. Accordingly, the pawl 28 is tilted from the engagement-release position P3 toward one side (arrow C2 direction side) around the first supporting shaft portion 34A, and the pawl engaging tooth 28D of the pawl 28 is engaged with the pawl tooth to be engaged 26B of the pawl engagement member 26. As a result, the rotation in the drawing-out direction (the drawing-out direction of the spool 12) of the pawl engagement member 26 is restricted (regulated). The position of the pawl 28 in a state where the pawl engaging tooth 28D of the pawl 28 can engage with the pawl tooth to be engaged 26B of the pawl engagement member 26 is referred to as an engaging position P4. The position of the sensor lever 30 in the state where the pawl 28 is positioned at the engaging position P4 is referred to as a second position P2.

The direction and magnitude of the attracting force by which the solenoid 32 attracts the second arm portion 30E (plate 30F) of the sensor lever 30 are indicated by an arrow F. The attracting force F is assumed to coincide with the direction from the N pole to the S pole or the direction from the S pole to the N pole which are the directions of the magnetic field generated by the solenoid 32.

### Functions and Effects of Present Embodiment

Next, functions and effects of the present embodiment will be described.

As shown in FIG. 1, according to the webbing winding device 10 of the present embodiment, the webbing 14 is drawn out from the spool 12, whereby the webbing 14 is attached to the occupant seated on the vehicle seat.

Here, when an acceleration sensor or the like provided in the vehicle detects that the deceleration/acceleration of the vehicle including the webbing winding device 10 of the present embodiment exceeds the predetermined deceleration/acceleration (in an emergency or the like of the vehicle), the solenoid 32 is actuated as shown in FIG. 4. When the solenoid 32 is actuated, the second arm portion 30E (plate 30F) of the sensor lever 30 is attracted to the solenoid 32, and the sensor lever 30 is tilted from the first position P1 to the second position P2. When the sensor lever 30 is tilted from the first position P1 to the second position P2, the sensor lever first abutting portion 30C of the first arm portion 30B of the sensor lever 30 presses the pawl first abutting portion 28C of the pawl 28. Accordingly, the pawl 28 is tilted from the engagement-release position P3 toward the engaging position P4, and the pawl engaging tooth 28D of the pawl 28 is engaged with the pawl tooth to be engaged 26B of the pawl engagement member 26. As a result, the rotation in the drawing-out direction (the drawing-out direction of the spool 12) of the pawl engagement member 26 is restricted.

Then, as shown in FIGS. 1 and 4, when the body of the occupant seated on the vehicle seat moves to the seat front side due to the deceleration of the vehicle and the webbing 14 is drawn out from the spool 12, the spool 12 is rotated in the drawing-out direction together with the main lock 22. Accordingly, the protrusion 22B of the main lock 24 is moved along the actuation groove 26A of the pawl engagement member 26 whose rotation is restricted, and the main lock engaging tooth 22A of the main lock 22 is engaged with the main lock tooth to be engaged 24A of the main lock engagement portion 24. As a result, the rotation in the drawing-out direction of the spool 12 is restricted (locked), and the drawing-out from the spool 12 of the webbing 14 is restricted. Accordingly, the body of the occupant seated on the vehicle seat is restrained by the webbing 14.

Incidentally, when the solenoid 32 is continuously actuated after completion of engagement of the main lock 22 (main lock engaging tooth 22A) with the main lock engagement portion 24 (main lock tooth to be engaged 24A), it is conceivable that displacement (return) toward the first position P1 of the sensor lever 30 is hindered, and displacement (return) toward the engagement-release position P3 of the pawl 28 is hindered. As a result, it is conceivable that the load on the members constituting the lock mechanism 16 increases and the rotation in the winding direction of the spool 12 is hindered. Hereinafter, a configuration for preventing or suppressing such a problem will be described.

### Configuration for Preventing or Suppressing Above Problem

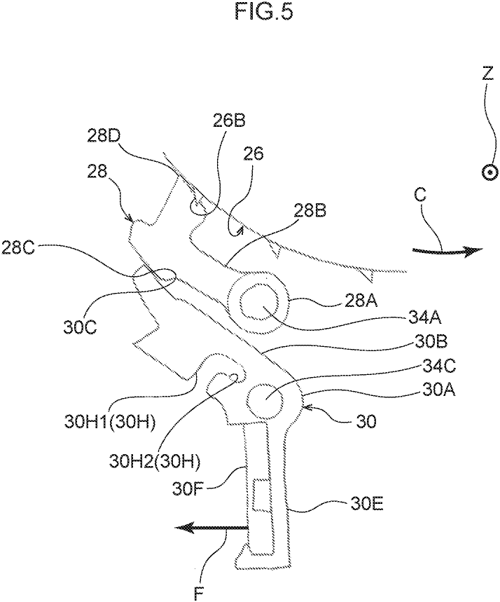

FIG. 5 shows a sensor lever 30, a pawl 28, and a pawl engagement member 26 to which a configuration for preventing or suppressing the above-described problem is applied. In this figure, illustration of the sensor lever-side spring locking portion 30D, the sensor lever second abutting portion 30G. and the like of the sensor lever 30 is omitted. The illustration on the second arm portion 28E side in the pawl 28 is omitted.

As shown in FIG. 5, a thinned groove 30H as a deformation allowing portion formed in an L shape when viewed from the axial direction is formed in the first arm portion 30B of the sensor lever 30 to which the present configuration is applied. The thinned groove 30H includes a first groove portion 30H1 in which a part of the first arm portion 30B is cut out so that the side opposite to the pawl 28 is opened and the pawl 28 side is closed. The thinned groove 30H includes a second groove portion 30H2 in which a portion from an end portion on the pawl 28 side of the first groove portion 30H1 in the first arm portion 30B to the tubular portion 30A is cut out.

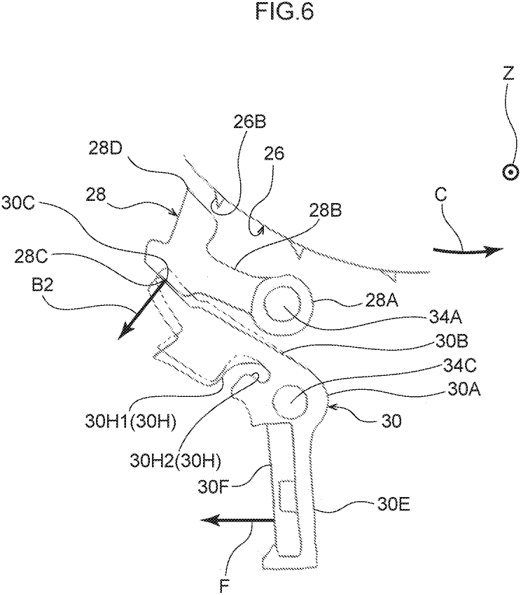

Then, in the configuration including the thinned groove 30H described above, when an excessive force such that the pawl 28 attempts to return from the engaging position P4 toward the engagement-release position P3 is input to the pawl 28 in a state where the sensor lever 30 is disposed at the second position P2 by actuation of the solenoid 32 being continued, that is, in a state where the plate 30F is disposed at a position closest to the solenoid 32, the sensor lever 30 (sensor lever first abutting portion 30C) is pressed by the pawl 28 (pawl first abutting portion 28C). Accordingly, as shown in FIG. 6, the first arm portion 30B of the sensor lever 30 is deformed from the state indicated by the two-dot chain line to the state indicated by the solid line with the edge portion of the thinned groove 30H as the deformation starting point. That is, deformation is made so that the groove interval of the thinned groove 30H is narrowed. As a result, only the sensor lever first abutting portion 30C side with respect to the portion where the thinned groove 30H is formed in the first arm portion 30B is displaced to the side opposite to the pawl 28 (the first position P1 side). Accordingly, displacement toward the engagement-release position P3 of the pawl 28 is allowed.

Here, the case where an excessive force such that the pawl 28 attempts to return from the engaging position P4 toward the engagement-release position P3 is input to the pawl 28 is assumed to be a case where an excessive pressing force B2 is generated at the contact point between the sensor lever 30 and the pawl 28 along with the fact that the spool 12 is rotationally urged in the winding direction by the urging force of the spiral spring or the like described above.

In the configuration described above, when an excessive force such that the pawl 28 attempts to return from the engaging position P4 toward the engagement-release position P3 is input to the pawl 28, it is possible to prevent the attracting force F of the solenoid 32 from hindering the displacement of the pawl 28 and a part of the sensor lever 30 respectively toward the engagement-release position P3 and the first position P1. In this configuration, it is not necessary to lower the attracting force F of the solenoid 32, and the rotation in the drawing-out direction of the spool 12 can be quickly locked at the time of rapid deceleration of the vehicle.

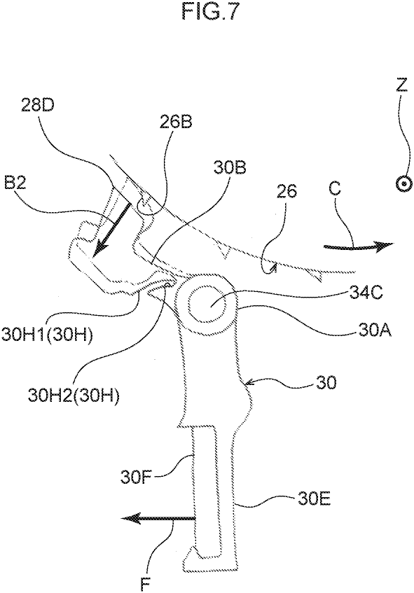

In the example described above, an example in which the pawl 28 is configured to be engaged with the pawl engagement member 26 along with the displacement of the sensor lever 30, that is, an example in which the sensor lever 30 is configured to be indirectly engaged with the pawl engagement member 26 through the pawl 28 has been described, but the present invention is not limited thereto. For example, as shown in FIG. 7, the sensor lever 30 may be configured to be directly engaged with the pawl engagement member 26. In the sensor lever 30 shown in FIG. 7, a portion corresponding to the above-described pawl 28 is denoted by the same reference numeral as the portion corresponding to the above-described pawl 28.

Although one embodiment of the present invention has been described above, the present invention is not limited to the above, and it is needless to say that various modifications other than the above can be made and implemented without departing from the gist of the present invention.

The disclosure of Japanese Patent Application No. 2020-056845 filed on Mar. 26, 2020 is incorporated herein by reference in its entirety.

1. A webbing winding device comprising:
a spool, a webbing to be attached to an occupant being wound around the spool, the spool being rotated in a drawing-out direction by the webbing being drawn out;
a displacement member configured to be displaced between a first position and a second position, rotation in the drawing-out direction of the spool being enabled in a state in which the displacement member is disposed at the first position, and rotation in the drawing-out direction of the spool being locked in a state in which the displacement member is disposed at the second position; and
an actuation portion, actuation of the actuation portion causing the displacement member to be displaced from the first position to the second position,
wherein the displacement member is provided with a deformation allowing portion that is deformed in a case in which a part of the displacement member disposed at the second position is pressed toward the first position, and the deformation allowing portion is allowed to be displaced toward the first position of the part of the displacement member.

2. The webbing winding device according to claim 1,
wherein the displacement member includes an attracting portion that is attracted to the actuated actuation portion, and
wherein, by the deformation allowing portion being deformed in a state in which the attracting portion is attracted to the actuation portion, displacement toward the first position of the part of the displacement member is allowed.

3. The webbing winding device according to claim 1, further comprising:
an engagement member that is configured to integrally rotate with the spool, and
a pawl that, by the displacement member being displaced from the first position to the second position, is pressed by the displacement member and displaced from an engagement-release position to an engaging position to be engaged with the engagement member, and
wherein, by an increase in a pressing force from the pawl to the displacement member due to the spool being rotationally urged in a winding direction, the deformation allowing portion is deformed and displacement toward the first position of the part of the displacement member is allowed.

4. The webbing winding device according to claim 1,
further comprising an engagement member that is configured to integrally rotate with the spool, the engagement member being engaged with the displacement member displaced to the second position, and
wherein, by an increase in a pressing force from the engagement member to the displacement member due to the spool being rotationally urged in a winding direction, the deformation allowing portion is deformed and displacement toward the first position of the part of the displacement member is allowed.
